(19) United States
(12) Patent Application Publication
(10) Pub. No.: US 2017/0332798 A1
(43) Pub. Date: Nov. 23, 2017

(54) SUPPORT APPARATUS ADJUSTABLE BY AN ELECTRIC MOTOR

(71) Applicant: de Werth Group AG, Zurich (CH)

(72) Inventor: Eckhart DEWERT, Goldingen (CH)

(21) Appl. No.: 15/487,241

(22) Filed: Apr. 13, 2017

Related U.S. Application Data
(63) Continuation of application No. PCT/EP2015/073056, filed on Oct. 6, 2015.

(30) Foreign Application Priority Data
Oct. 16, 2014 (DE) 10 2014 115 084.8
Oct. 17, 2014 (DE) 20 2014 104 963.0

(51) Int. Cl. A47C 20/04; A47C 19/04; A47C 20/08; A61G 7/015

(52) U.S. Cl. CPC A47C 20/041; A47C 20/08; A47C 19/045; A61G 7/015

(57) ABSTRACT

A support apparatus adjustable by an electric motor for supporting padding of a seat and/or a reclining furniture, in particular a mattress of a bed, has a base body with an outer frame. Outer frame is configured and set up for resting on a support surface and an inner frame having at least two support parts adjustable relative to one another. Support apparatus has an electromotive drive apparatus with at least one adjustment element in drive connection with at least one electric motor, which for adjusting at least one support part is in drive connection with the electric motor. The outer frame is formed at least in sections by a C-shaped profiled rail. The C-shaped profiled rail forms a linear guide. The liner guide guides the adjustment element in the direction of the profile in a linearly displaceable manner.

### CROSS-REFERENCE TO RELATED APPLICATIONS

This application is a continuation of Application No. PCT/EP2015/073056, filed Oct. 6, 2015, and this application claims the priority of German Application No. 20 2014 104 963.0, filed Oct. 17, 2014, and this application claims the priority of German Application No. 10 2014 115 084.8, filed Oct. 16, 2014, and each of which is incorporated herein by reference.

### FIELD OF THE INVENTION

The invention relates to a support apparatus adjustable by an electric motor for supporting padding of a seating and/or reclining furniture, in particular a mattress of a bed.

### BACKGROUND OF THE INVENTION

Such support apparatuses are generally known in the form of slatted frames and, for example, serve to support a mattress of a bed in a planar manner. The known support apparatuses have a base body having an outer frame, which is configured and set up for resting on a support surface. The outer frame forms a supporting structural element, for example, to keep the support apparatus in a bed frame. For specific embodiments, the outer frame is also configured for resting on the floor. Furthermore, the base body has an inner frame which has at least two support parts adjustable relative to one another. For example, the inner frame may have a stationary center support part which is attached to the outer frame. An upper body support part and a leg support part may be pivotably connected to the ends of the center support part at a distance to each other in the longitudinal direction of the support apparatus. To increase the comfort, a head support part may be pivotably connected to the upper body support part at its end facing away from the center support part, while a calf support part may be pivotably connected to the leg support part at its end facing away from the center support part. To adjust the support parts of the inner frame relative to one another, an electromotive drive apparatus is provided, which has at least one adjustment element being in drive connection with at least one electric motor, which for adjusting at least one support part is in drive connection with the electric motor. The inner frame being configured in such a manner has the operating elements of the drive train of the drive apparatus necessary for adjusting the support parts relative to one another.

A support apparatus adjustable by an electric motor is known from DE 19962541 C2, in which the base body has longitudinal beams configured as a hollow profile, the complete drive including a drive motor being accommodated in one of the longitudinal beams.

A support apparatus adjustable by an electric motor for a mattress of a bed is known from WO 96/29970, in which parts of the outer frame are configured as a hollow profile, parts of the drive apparatus being accommodated in the hollow profile. The drive motor is disposed outside of the hollow profile at an inside of a part of the outer frame.

A support apparatus adjustable by an electric motor for supporting padding of a seating and/or reclining furniture, in particular a mattress of a bed, is known respectively from DE 10 2013 110 094 A1 and DE 10 2013 110 096 A1, which has a base body having an outer frame configured and set up for resting on a support surface, and which has an inner frame having at least two support parts adjustable relative to one another. Furthermore, the known support apparatus has an electromotive drive apparatus, which has at least one adjustment element being in drive connection with at least one electric motor, which for adjusting at least one support part is in drive connection with the electric motor.

An electromotive furniture drive as an add-on component for slatted frames is known from WO 2004/028305 A1, in which the housing of the furniture drive is formed by a profiled rail section. Similarly, furniture drives are also known from DE 20302139 U1 and DE 20302142 U1.

An electromotive furniture drive as add-on component for slatted frames is also known from WO 2011 29500 A1 (equivalent to DE 10 2009 036 402 A1), in which two drive units are provided with respectively one individual housing, the housings being disposed as a supporting structural element at a profiled rail.

### OBJECTS AND SUMMARY OF THE INVENTION

An object of the invention is to provide a support apparatus adjustable by an electric motor, which has a simple design and is robust.

This object is achieved by the invention set forth herein.

The invention provides that a support apparatus adjustable by an electric motor includes an outer frame formed at least in sections by a C-shaped profiled rail. Such a C-shaped profiled rail has the cross section of a C, the C-shaped profile being formed in that the free legs of a U-shaped profile are perpendicular and have edges directed towards each other. According to the invention, the C-shaped profiled rail forms a linear guide at which the adjustment element is guided in a linearly movable manner in the direction of the profile.

Simultaneously, the invention uses a supporting structural element of the support apparatus, namely the outer frame, as an operating element, namely as a linear guide for a linearly movable adjustment element. In this manner, a particularly simple design having few components results.

A further advantage of the support apparatus according to the invention is that the support apparatus is very robust. A large selection of suitable C-shaped profiled rails made from the most different materials, from metal as well as also nonmetallic raw materials, is available.

According to the invention, any suitable part of the outer frame may be formed as a C-shaped profiled rail. To this extent, an advantageous further embodiment of the invention provides that the outer frame has two longitudinal beams at a distance from each other extending transversely to the longitudinal direction of the support apparatus, of which at least one is at least in sections formed as a C-shaped profiled rail. Advantageous further embodiments of the invention however provide that both longitudinal beams at least in sections are formed as a C-shaped profiled rail and that the openings of the C-shaped profiled rail of the two longitudinal beams are facing each other or that both longitudinal beams at least in sections are formed as a C-shaped profiled rail and that the openings of the C-shaped profile are mutually parallel. An advantageous further embodiment of the last-mentioned embodiment provides that the openings of the C-shaped profile are directed upward when the support apparatus is in a position of use.

According to the invention it generally suffices if the outer frame is formed exclusively by longitudinal beams at a distance to one another extending transversely to the longitudinal direction of the support apparatus. To increase the structural strength of the outer frame, an advantageous further embodiment of the invention provides that the longitudinal beams of the outer frame are connected to one another at their ends or in the area of their ends by transverse beams.

In accordance with the respective requirements, the C-shaped profiled rails or C-shaped profiled rails may be made of metal and/or plastic.

To enable a pivoting of the support parts of a slatted frame relative to one another in a simple manner, an advantageous further embodiment of the invention provides that the adjustment element is a pivot lever configured and set up in such a manner that the pivot lever pivots in a linear motion along the linear guide under the effect of the drive apparatus for adjusting the support parts relative to one another.

It is advantageous in the previously mentioned embodiment if the pivot lever is linearly movable under the effect of a traction means being in drive connection with the drive apparatus, as provided by an advantageous further embodiment.

In this instance, the traction means is advantageously the pull cable of a Bowden cable, as provided by one further embodiment. Respective Bowden cables are available as relatively simple and cost-effective standard components and are suited for transferring large forces.

An extremely advantageous further embodiment of the invention provides that the cross section of the adjustment element is configured in such a manner that a first end of the adjustment element facing the bottom of the C-shaped profiled rail is captured in the C-shaped profile and a second end of the adjustment element facing away from the first end protrudes through the opening of the C-shaped profile and is operatively connected to a to-be adjusted support part. In this embodiment, the adjustment element is captured in the C-shaped profile and is operatively connected through the opening of the C-shaped profile to the to-be-adjusted support part.

A further embodiment of the invention includes a support apparatus adjustable by an electric motor for supporting padding of a seat or a reclining furniture, and which includes:

a base body, the base body having an outer frame for resting on a support surface and an inner frame having at least two support parts adjustable relative to one another;

a drive apparatus, the drive apparatus having at least one adjustment element in drive connection with at least one electric motor which for adjusting at least one support part is in drive connection with the at least one electric motor;

an outer frame, at least in sections, being formed by a C-shaped profiled rail; and

the C-shaped profiled rail forming a linear guide, by which the at least one adjustment element is guided in the direction of the profile in a linearly displaceable manner.

Relative terms such as left, right, up, and down are for convenience only and are not intended to be limiting.

The invention is subsequently described in greater detail in reference to the appended drawing, in which the embodiments of a support apparatus according to the invention are illustrated in a strongly schematized manner. In so doing, all features described in the description, illustrated in the drawing and claimed in the claims constitute, individually and together in any suitable combination, the subject matter of the invention, regardless of their summary in the claims and their back reference and regardless of their description or illustration in the drawing. The subject matter and the content of the disclosure of the present application also include the various combinations and subcombinations of individual features of the various embodiments which are omitted or are replaced by other features.

### BRIEF DESCRIPTION OF THE DRAWINGS

FIG. 1 shows a perspective view of an illustrated embodiment of a support apparatus in the form of a slatted frame in an unadjusted starting position;

FIG. 2 shows, illustrated in the same manner as in FIG. 1, the illustrated embodiment according to FIG. 1 in an end position of the adjustment movement of an upper body support part and of a leg support part;

FIG. 3 shows, illustrated in the same manner as in FIG. 1, the illustrated embodiment according to FIG. 1, some components being omitted for purposes of clarity;

FIG. 4 shows, illustrated in the same manner as in FIG. 2, details of a drive apparatus of the support apparatus according to FIG. 1;

FIG. 5 shows, illustrated in the same manner as in FIG. 4, details of a drive apparatus from a different perspective;

FIG. 6 shows, illustrated in the same manner as in FIG. 5, however in enlarged scale, a detail from FIG. 5;

FIG. 7 shows, illustrated in the same manner as in FIG. 5, the drive apparatus from FIG. 5, and for clarifying the adjustment of the head support part relative to the upper body support part, further components of the support apparatus are omitted;

FIG. 8 shows, illustrated in the same manner as in FIG. 7, however from a different perspective, the support apparatus according to FIG. 2, further components of the support apparatus being omitted;

FIG. 9 shows, from a different perspective and in enlarged scale, a detail from FIG. 8;

FIG. 10 shows a perspective view of a first embodiment of a support apparatus according to the invention in the starting position of the adjustment movement, in which the support parts span a horizontal support plane;

FIG. 11 shows, illustrated in the same manner as in FIG. 10, the support apparatus according to FIG. 10, the support parts being in an adjustment position which lies between the starting position and the end position of the adjustment movement;

FIG. 12 shows, illustrated in the same manner as in FIG. 10, the support apparatus according to FIG. 10, the support parts being in the end position of the adjustment movement;

FIG. 13 shows, illustrated in the same manner as in FIG. 10, the support apparatus according to FIG. 10, and for clarifying the design of the support apparatus, components of the support apparatus are omitted;

FIG. 14A shows, illustrated in the same manner as in FIG. 13, however in a slightly changed perspective, the support apparatus according to FIG. 10;

FIG. 14B shows, illustrated in the same manner as in FIG. 13, the support apparatus according to FIG. 10 in the end position of the adjustment movement;

FIG. 15 shows, illustrated in the same manner as in FIG. 1, a second embodiment of a support apparatus according to the invention in a first adjustment position;

FIG. 16 shows, illustrated in the same manner as in FIG. 15, the support apparatus according to FIG. 15 in a second adjustment position corresponding to a maximal adjustment position;

FIG. 17 shows, illustrated in the same manner as in FIG. 15, however in an enlarged scale, a detail from FIG. 15, further components of the support apparatus being omitted for purposes of clarity;

FIG. 18 shows, illustrated in the same manner as in FIG. 17, a detail from FIG. 17;

FIG. 19 shows, illustrated in the same manner as in FIG. 18, the detail from FIG. 18 in an adjustment position corresponding to the adjustment position of the support apparatus shown in FIG. 16;

FIG. 20 shows in a perspective view a component of a third embodiment of a support apparatus according to the invention in a starting position of the adjustment movement;

FIG. 21 shows, illustrated in the same manner, the embodiment according to FIG. 20, a profiled rail being omitted for purposes of illustration;

FIG. 22 shows, illustrated in the same manner as in FIG. 21, the embodiment according to FIG. 22 in a first adjustment position;

FIG. 23 shows, illustrated in the same manner as in FIG. 22, the embodiment according to FIG. 21 in a second adjustment position corresponding to an end position of the adjustment movement;

FIG. 24 shows in a perspective view a fourth embodiment of a support apparatus according to the invention in a starting position of the adjustment movement;

FIG. 25 shows, illustrated in the same manner as in FIG. 24, the support apparatus according to FIG. 25 in a first adjustment position;

FIG. 26 shows, illustrated in the same manner as in FIG. 24, the support apparatus according to FIG. 24 in a second adjustment position corresponding to an end position of the adjustment movement;

FIG. 27 shows, illustrated in the same manner as in FIG. 24, the support apparatus according to FIG. 24, components of the support apparatus being omitted for purposes of illustration;

FIG. 28 shows, illustrated in the same manner as in FIG. 27, the support apparatus according to FIG. 24 in the end position of the adjustment movement;

FIG. 29 shows a detail from FIG. 28, further components of the support apparatus being omitted; and

FIG. 30 shows a detail from FIG. 29, further components of the support apparatus being omitted.

### DETAILED DESCRIPTION OF THE INVENTION

In the figures of the drawing, the same or corresponding components are provided with the same reference characters. The drawing schematically illustrates embodiments of a support apparatus according to the invention. For purposes of illustration, components of the support apparatus are omitted in individual figures of the drawing. These components are to be supplemented accordingly.

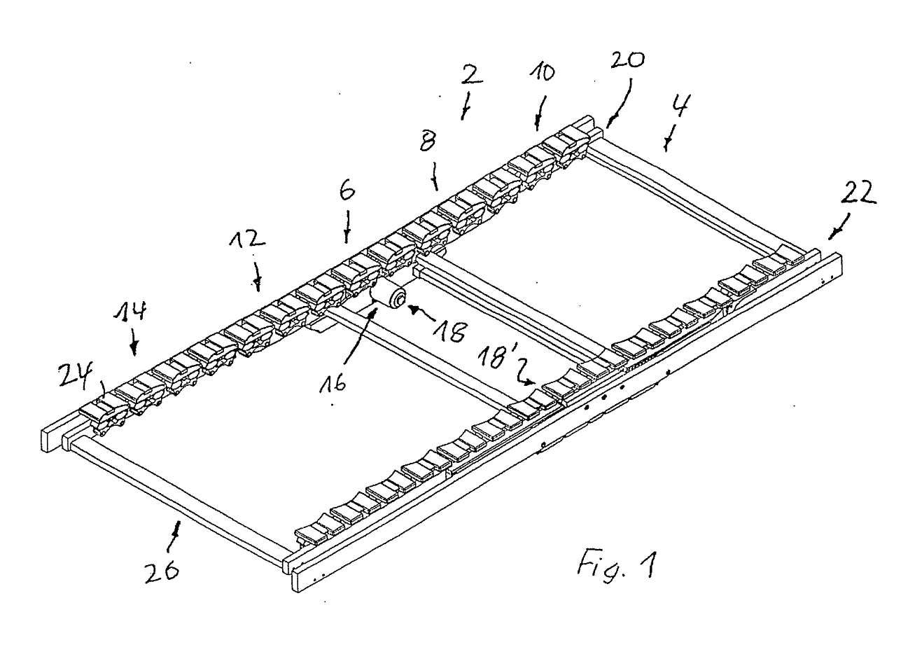

To describe an illustrated embodiment of a support apparatus adjustable by an electric motor according to the invention, reference is subsequently made to FIGS. 1 through 9.

FIG. 1 shows an illustrated embodiment of a support apparatus 2 adjustable by an electric motor according to the invention, which in the illustrated embodiment is configured as a slatted frame. Support apparatus 2 has a base body 4 having support parts, by which a mattress of a bed is supported when using support apparatus 2. For purposes of illustration, the mattress is consistently omitted in the drawing.

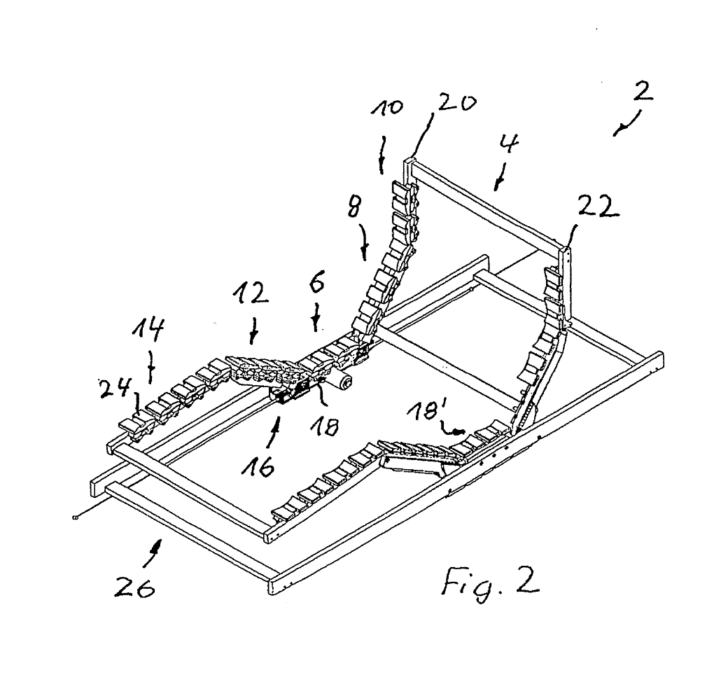

In the shown illustrated embodiment (see FIG. 2), support apparatus 2 has a stationary center support part 6, to which an upper body support part 8 is connected articulatedly and pivotably adjustable about a horizontal pivot axis, and the end of upper body support part 8 facing away from center support part 6 is connected articulatedly and pivotably adjustable about a horizontal pivot axis to a head support part 10. The end of center support part 6 facing away from upper body support part 8 is connected articulatedly and pivotably adjustable about a horizontal pivot axis to a leg support part 12, and the end of leg support part 12 facing away from the center support part 6 is connected articulatedly and pivotably adjustable about a horizontal pivot axis to a calf support part 14.

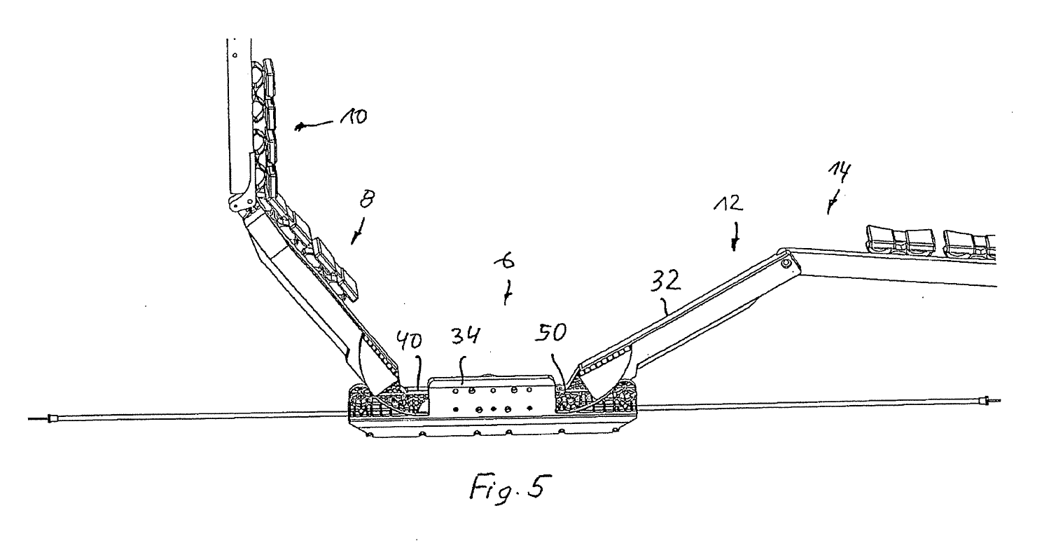

To pivotably adjust support parts 6 through 14 relative to one another, an electromotive drive apparatus 16 is provided, having a drive unit 18 which is disposed at a first longitudinal beam 20 at center support part 6. A further drive unit 18′ of electromotive drive apparatus 16 is disposed at a second longitudinal beam 22 at a distance to first longitudinal beam 20 extending transversely to the longitudinal direction of support apparatus 2. Drive units 18, 18′ further below are described in greater detail on the basis of FIGS. 5 through 9.

Slat holders are connected to support parts 6 through 14, at which elastic slats supporting the mattress are held when support apparatus 2 is in use. In the drawing (see FIG. 1 and FIG. 2), only one slat holder is provided with reference character 24. For purposes of illustration, the elastic slats are not shown in the drawing.

FIG. 1 shows support apparatus 2 in an unadjusted starting position of support parts 6 through 14, in which support parts 6 through 14 together span a horizontal or nearly horizontal support plane for supporting the mattress.

FIG. 2 shows support apparatus 2 in an end position of the adjustment movement, in which upper body support part 8 including head support part 10 and leg support part 12 including calf support part 14 are maximally pivoted and, hence, adjusted relative to center support part 6. The starting position of support apparatus 2 corresponds to a reclining position of support part 2, while the end position shown in FIG. 2 corresponds to a seating position. Any adjustment positions are possible between the starting position and the end position.

For purposes of illustration, power supply and control means for actuating drive unit 16 are not shown n the drawing. The design and mode of operation of respective power supply and control means are however generally known to those skilled in the art and, for this reason, are here not described in greater detail.

In the illustrated embodiment, upper body support part 8 is configured and set up in such a manner that the pivot axis is translationally movably mounted in the longitudinal direction of support apparatus 2. As a result, it is prevented that the mattress is compressed during a pivotal adjustment of upper body support part 8 relative to center support part 6. In so doing, a high comfort for a user of support apparatus 2 is ensured even in the adjusted position of upper body support part 8. As is apparent from a comparison of FIGS. 1 and 2, the translationally movable positioning of the pivot axis results in that, during an adjustment from the starting position in the direction of the end position, the distance between the slat holders disposed adjacent to one another in the starting position (see FIG. 1) increases at center support 6 and upper body support part 8. In this way, a compression of the mattress is prevented.

The same also applies for an adjustment of leg support part 12 relative to center support part 6. The pivot axis assigned to leg support part 12 is likewise translationally movably mounted in the longitudinal direction of support apparatus 2. Accordingly, the distance between the slat holders at center support part 6 and leg support part 12, which in the starting position of the adjustment movement (see FIG. 1) are disposed adjacent to one another, increases during the pivot adjustment of leg support part 12 relative to center support part 6. Thus, a compression of the mattress is also prevented in the area of leg support part 12. On account of the adjustment and translational movement of upper body support part 8 and of leg support part 12 relative to center support part 6 being independent from one another, a compression of the mattress is prevented in any adjustment position and, for this reason, the mattress is decompressed in all adjustment positions of support apparatus 2.

As is apparent from FIGS. 1 and 2, support apparatus 2 has an outer frame 26, to which base body 4 is fastened.

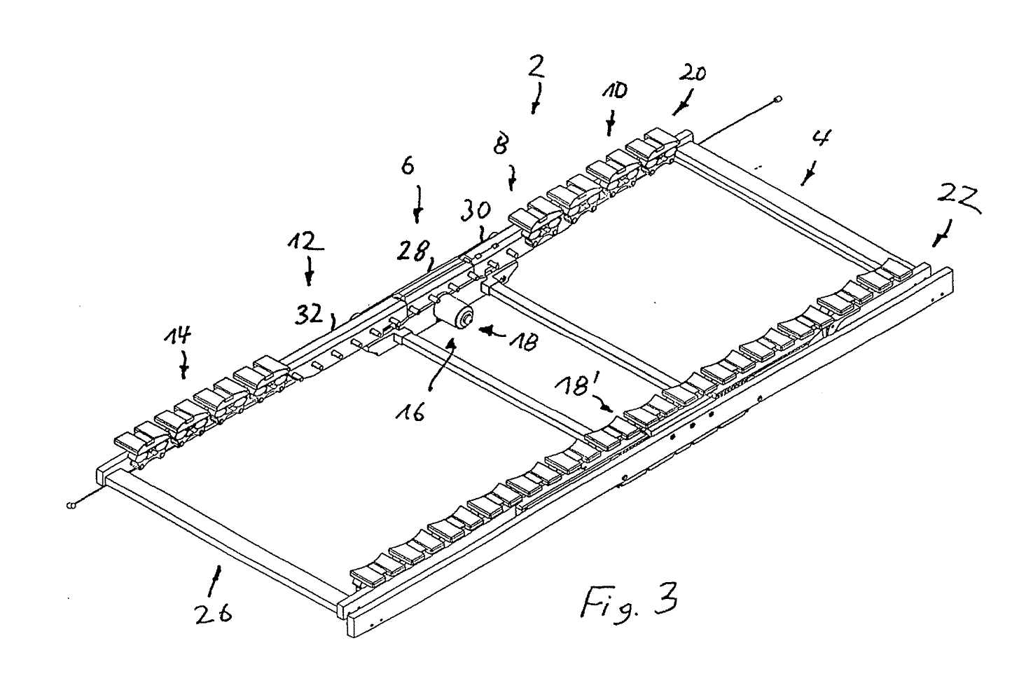

FIG. 3 shows support apparatus 2 according to FIG. 1, slat holders being omitted at first longitudinal beam 20 in the area of center support part 6, of upper body support part 8 and of leg support part 12 for purposes of illustration, so that first longitudinal beams 28, 30, 32 of center support part 6 or of upper body support part 8 or of leg support part 12 are visible.

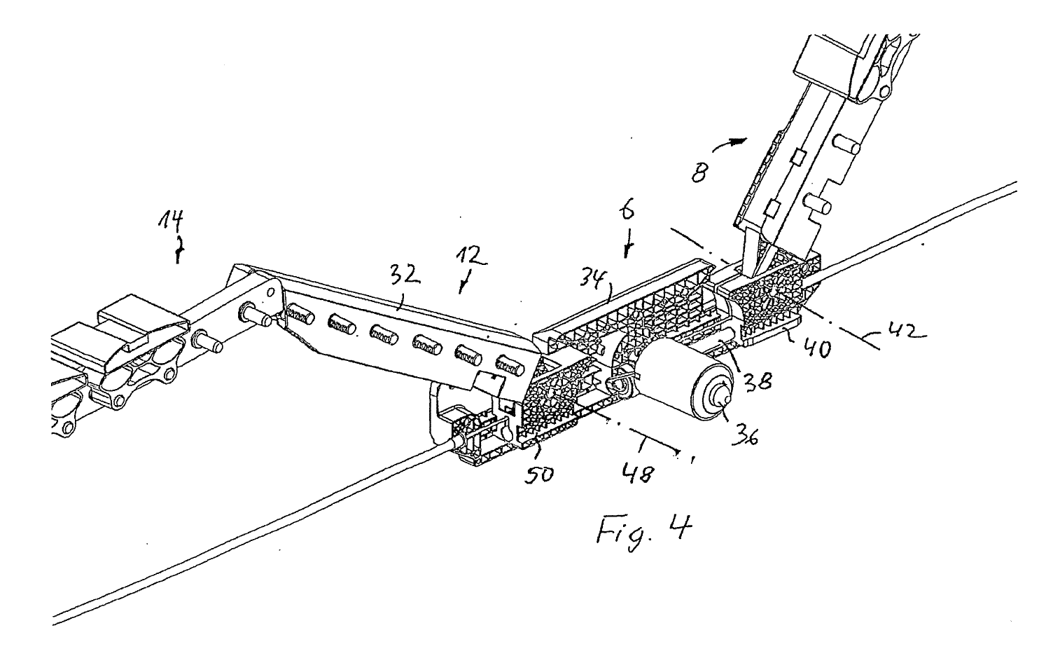

On the basis of FIGS. 4 through 6, the design of support apparatus 2 with regard to drive apparatus 16 is subsequently explained in greater detail.

In the following, only drive unit 18 assigned to first longitudinal beam 20 is explained in greater detail. The drive unit assigned to second longitudinal beam 22 is designed accordingly and, for this reason, is here not explained in greater detail.

Drive unit 18 has a base element 34, which in this embodiment is formed by an injection-molded part made of plastic and at which the components of drive unit 18 are disposed or mounted. An electric motor 36 is disposed at base element 34, the drive shaft of which is in rotary drive connection with a threaded spindle 38 mounted at base element 34 in a fixed and rotary-drivable manner. In the illustrated embodiment, the rotary drive connection between the drive shaft of electric motor 36 and threaded spindle 38 is established via a worm gear. The driving element of drive unit 18 is formed by a spindle nut 40 which is disposed non-rotatably on and movably in the axial direction of threaded spindle 38.

Spindle nut 40 forms a slide at which a pivot axis 42 is mounted, about which upper body support part 8 relative to center support part 6 (see FIG. 3 and FIG. 4) is pivotable.

FIG. 5 shows drive unit 18 from the side facing away from electric motor 36.

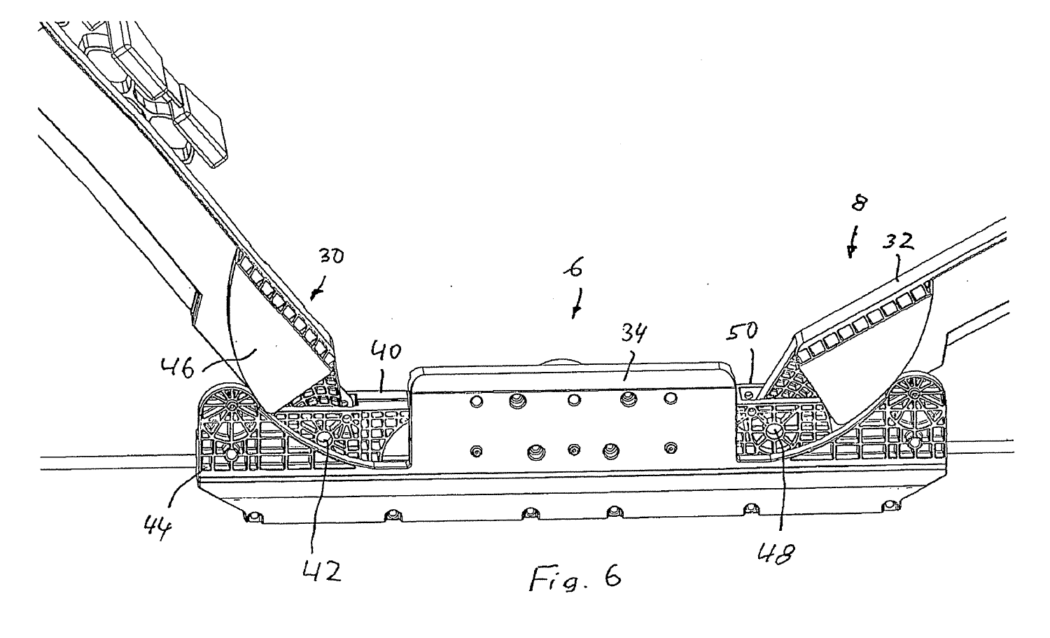

FIG. 6 shows drive unit 18 illustrated in the same manner as in FIG. 5, however in enlarged scale.

The adjustment of upper body support part 8 (second support part) relative to center support part 6 (first support part) is carried out in such a manner that the second support part or a component thereto connected during a translational movement runs up against a first raising element and in this instance pivots. As explained on the basis of 4 a translational movement of spindle nut 40 and, for this reason, of upper body support part 8 relative to center support part 6 is effected with the aid of spindle drive 38. In the shown embodiment, the pivot movement of upper body support part 8 relative to center support part 6 is effected in that at the side next to the translational trajectory of spindle nut 40 and, therefore, of upper body support part 8, a first raising element 44 is disposed, against which a second raising element 46 connected to upper body support element 8 runs up so that, in this instance, upper body support part 8 is pivoted relative to center support part 6.

First raising element 44 is integrally formed with first longitudinal beam 30 of upper body support part 8, first longitudinal beam 30 and second raising element 46 in the shown embodiment also being formed by an in part made of plastic. In so doing, in the shown illustrated embodiment, second raising element 46 is connected to upper body support part 8 in a pivotably fixed manner. As a variation of this illustrated embodiment, the second raising element, however, may also be movably connected to upper body support part 8, as long as a raising of upper body support part 8 and, therefore, a pivoting of the same relative to center support part 6 is effected in the desired manner.

As is apparent from FIG. 6, in the shown illustrated embodiment, raising elements 44, 46 in a cross section are formed as curved bodies, raising elements 44, 46 in the shown embodiment in a cross section being substantially formed in a complementary manner. As is apparent from FIG. 6, upper body support part 8 in the starting position (see FIG. 1) is horizontally disposed, and the dead center of the pivot adjustment of upper body support part 8 is overcome in the translational movement of spindle nut 40 and, therefore, the pivot movement is carried out.

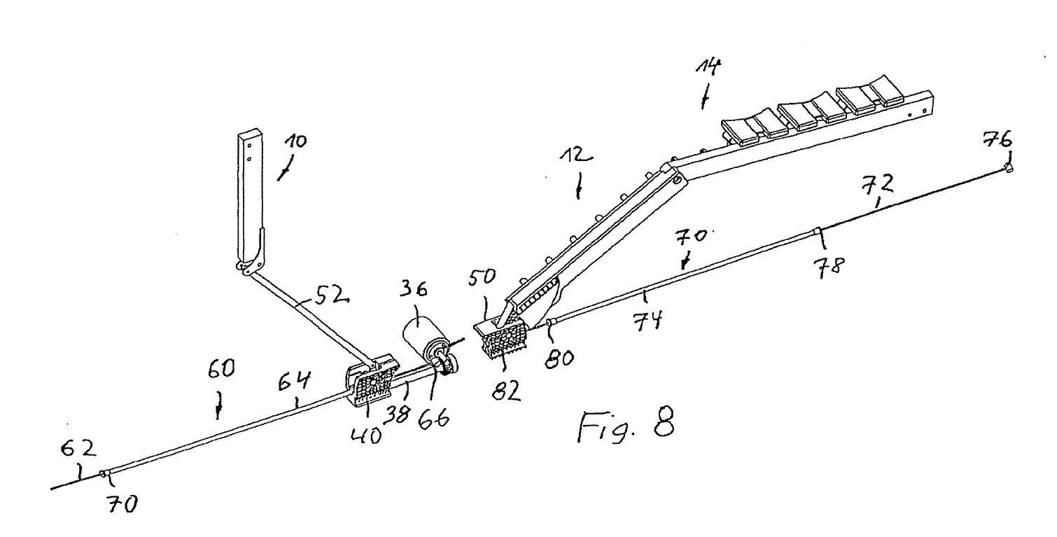

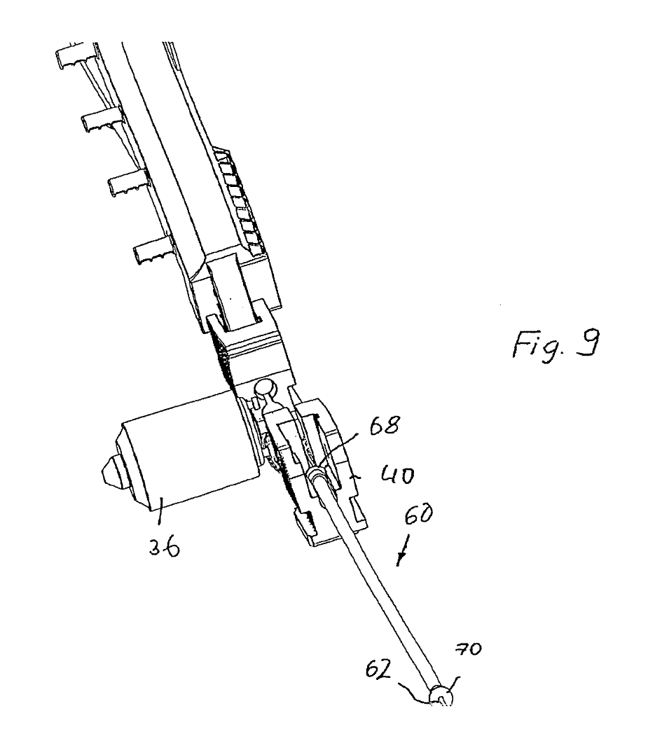

To prevent a distortion of upper body support part 8 during an adjustment, the translational movement of slide 40 formed by spindle nut 40 of first drive unit 18 is transferred to a translationally movably mounted slide of the drive unit assigned to second longitudinal beam 22. In this instance, synchronization means are provided, which are explained in greater detail further below on the basis of FIGS. 8 and 9. This slide translationally movably mounted at the drive unit provided at second longitudinal beam 22, is driveless so that electric motor 36 affects the adjustment of the two longitudinal beams of upper body support part 8, and the synchronization means ensuring that upper body support part 8 is not distorted.

The adjustment of leg support part 12 is carried out in a corresponding manner. For this purpose, first longitudinal beam 32 of leg support part 12 is pivotably mounted about a pivot axis 48 at a slide 50, which is translationally movably mounted at base element 34 of drive unit 18.

The drive unit assigned to second longitudinal beam 22 correspondingly has an electric motor actuating a slide, which is formed by the spindle nut of a spindle drive, as has been described previously for slide 40. Translational movements of this actuated slide of the drive unit assigned to second longitudinal beam 22 are transferred to slide 50 by the synchronization means explained in greater detail further below. Thus, the slides assigned to upper body support part 8 are actuated by electric motor 36, while the slides assigned to leg support part 12 are actuated by the electric motor which is assigned to the drive unit assigned to second longitudinal beam 22. In other words, electric motor 36 effects an adjustment of upper body support part 8 including head support part 10, while the respective electric motor assigned to second longitudinal beam 22 effects an adjustment of the leg support part including the calf support part.

On the basis of the pivotably movable connection of calf support part 14 to leg support part 12, calf support part 14 pivots on the basis of its gravity relative to leg support part 12 if the leg support part is pivoted. The end position of the adjustment movement (see FIG. 2) is defined by a stop acting between leg support part 12 and calf support part 14.

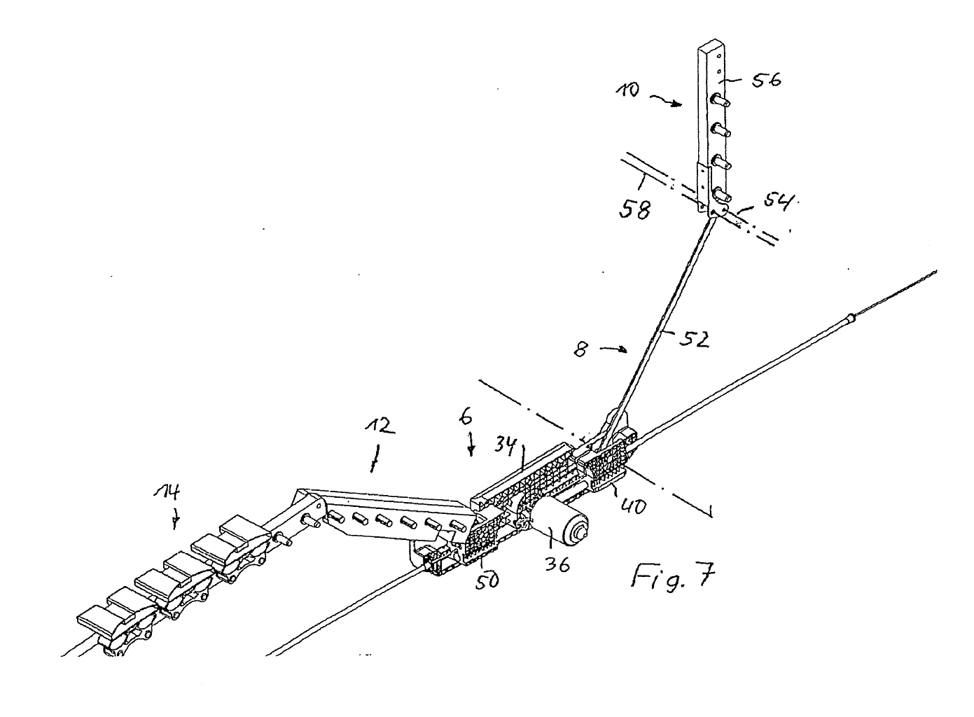

On the basis of FIG. 7, the adjustment of head support part 10 relative to upper body support part 8 is subsequently explained.

To adjust head support part 10, a rod-like adjustment element 52 is provided, the one end of which is mounted in a pivotably movable manner and coaxially to pivot axis 42 at slide 40. The other end of adjustment element 52 is mounted about a pivot axis 54 at a first longitudinal beam 56 of head support part 10. Pivot axis 54 is mounted eccentrically to a pivot axis 58, about which head support part 10 relative to upper body support part 8 is pivotable. Owing to that pivot axis 54 eccentrically positioned to pivot axis 58, head support part 10, when pivoting upper body support part 8 relative to center support part 6, pivots relative to upper body support part 8 until the end position of the adjustment movement is reached (see FIG. 2).

The return of support parts 8 through 14 relative to center support part 6 to the starting position (see FIG. 1) takes place under the weight force of support parts 6 through 12, if necessary also under the load of a person resting on support apparatus 2, and the drive apparatus remaining switched-on.

In the illustrated embodiment, first left element 44 is, relative to center support part 6 (first support part), fixedly disposed, while second raising element 46 is movably disposed. Corresponding to the respective requirements, it is however also possible to dispose both raising elements 44, 46 movably relative to the first support part.

The synchronization means according to the invention have a Bowden cable 60 (see FIG. 8), having a pull cable (cable core) 62 which is accommodated in a flexible yet, in the direction of the pull, pressure-resistant sheathing 64. An end 66 of pull cable 62 is fixed to stationary base element 34. End 68 of the sheathing facing end 66 of pull cable 62 is fixed in a displaceably fixed manner to slide 40, as is apparent from FIG. 9.

As previously explained, a slide is provided at second longitudinal beam 22, which corresponds to slide 40; however, it is configured in a driveless manner.

The other end of pull cable 62 facing away from end 66 is fixed to this driveless slide in a displaceably fixed manner, while other end 69 of the sheathing facing away from end 68 is fixed in a displaceably fixed manner to a base element assigned to second longitudinal beam 22, at which the driveless slide is mounted in a translationally movable manner. For purposes of illustration, the connection of pull cable 62 and of end 69 of the sheathing to this driveless slide is not shown in the drawing.

In the starting position of the adjustment movement, the distance of spindle nut 40 to end 66 of the pull cable fixed to base element 34 is minimal. During the adjustment movement, spindle nut 40 in FIG. 8 moves translationally to the left, upper body support part 8 pivoting in the previously described manner.

In the translational movement of spindle nut 40 in FIG. 8 to the left, pull cable 62 of Bowden cable 60 remains stationary, while the sheathing in FIG. 8 is displaced to the left. On the basis of this displacement of the sheathing, the distance of end 70 of Bowden cable 60 to the assigned end of pull cable 62 is reduced. Since end 69 at the further base element assigned to second longitudinal beam 22 and the pull cable are fixed at the driveless slide assigned to this base element, this slide moves synchronously to the slide formed by spindle nut 40. In this manner, the adjustment force applied by electric motor 36 is transmitted synchronously or nearly synchronously to the two longitudinal beams of upper body support part 8 so that a distortion of upper body support part 8 is prevented during the adjustment movement.

As already previously described, the drive unit assigned to second longitudinal beam 22 also has a slide in the form of a spindle nut actuated by an electric motor, the configuration corresponding to the configuration described for base element 34, electric motor 36 and spindle drive 38, 40. A Bowden cable 70 having a pull cable 72 and a sheathing 74 serve as synchronization means. Corresponding to the configuration described for end 66 of Bowden cable 60, end 76 of Bowden cable 70 is fixed to base element 34 assigned to second longitudinal beam 22, while end 78 of sheathing 74 facing end 76 of pull cable 72 is fixed to this spindle nut. End 80 of sheathing 74 facing away from end 78 is fixed to base element 34 not shown in FIG. 8, while the end of pull cable 72 facing away from end 76 is fixed to driveless slide 82 assigned to leg support part 12.

During a movement of the spindle nut assigned to second longitudinal beam 22 in the direction of the end position of the adjustment movement, the distance between slide 82 and end 80 of sheathing 71 is reduced, so that slide 82 in FIG. 8 moves to the right. In this manner, the adjustment force by the electric motor assigned to second longitudinal beam 22 is transmitted synchronously to the two longitudinal beams of leg support part 12.

As already described previously, electric motor 36 assigned to first longitudinal beam 20 effects in this instance an adjustment of upper body support part 8 including head support part 10 relative to center support part 6, while the electric motor assigned to second longitudinal beam 22 effects an adjustment of leg support part 12 including calf support part 14.

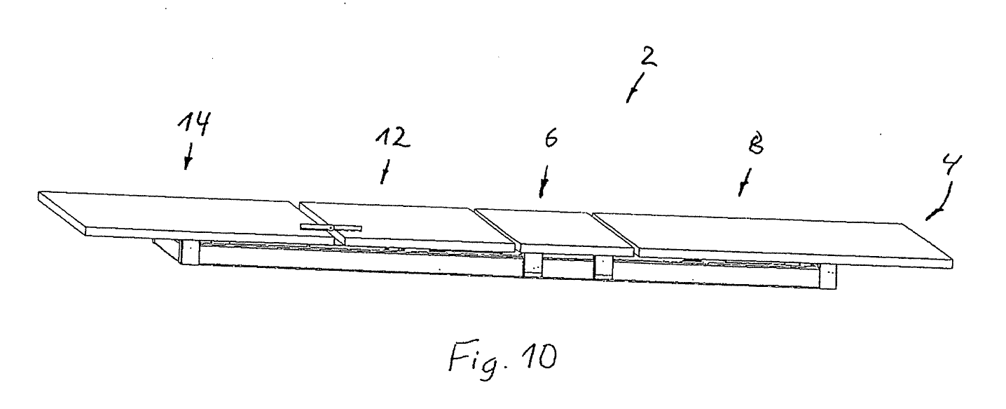

Subsequently, reference is made to FIGS. 10 through 14B.

FIG. 10 shows a first embodiment of a support apparatus according to the invention in a view corresponding to FIG. 1. The first embodiment differs from the illustrated embodiment first in that support apparatus 2 is configured for supporting a box spring mattress. Since for such a box spring mattress a spring system, which for a slatted frame is provided by elastic slats, is integrated into the mattress, in the embodiment according to FIG. 10, the support parts are formed in a panel-like manner.

For the shown embodiment, the support apparatus is formed by four parts and has a stationary center support part 6, to which, on the one hand, an upper body support part 8 and, on the other hand, a leg support part 12 along with a calf support part 14 is pivotably adjustably connected.

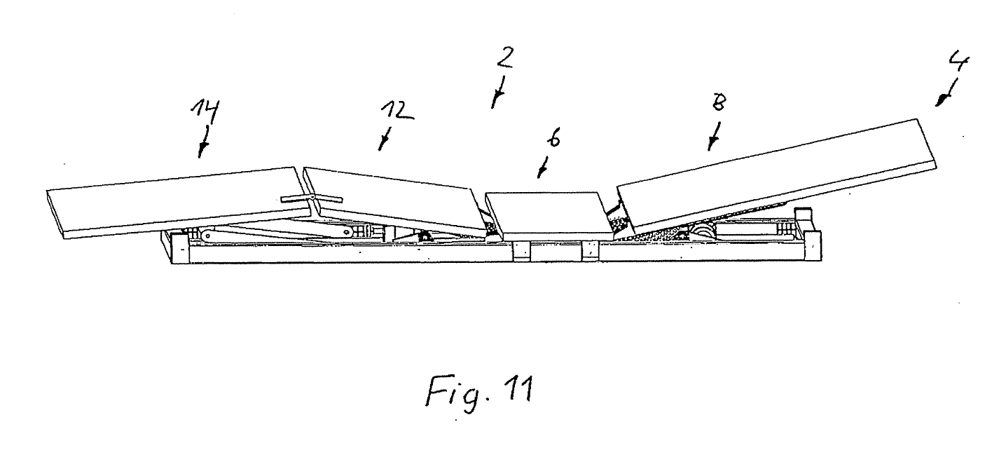

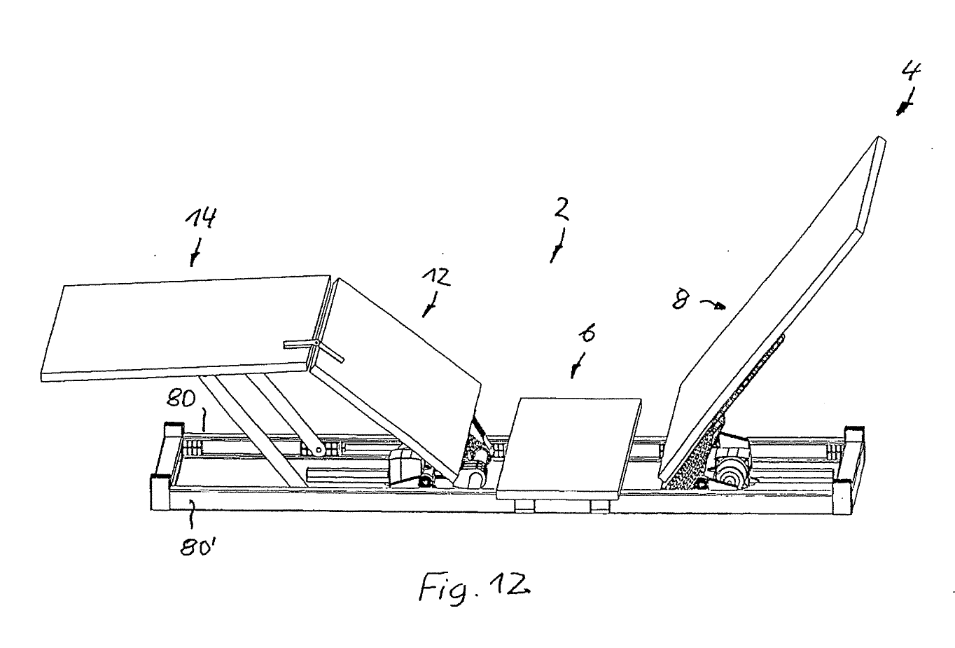

FIG. 11 shows support apparatus 2 in an adjustment position which lies between the starting position of the adjustment movement illustrated in FIG. 10 and an end position of the adjustment movement illustrated in FIG. 12, in which support parts 8, 12, 14 are maximally adjusted relative to center support part 6.

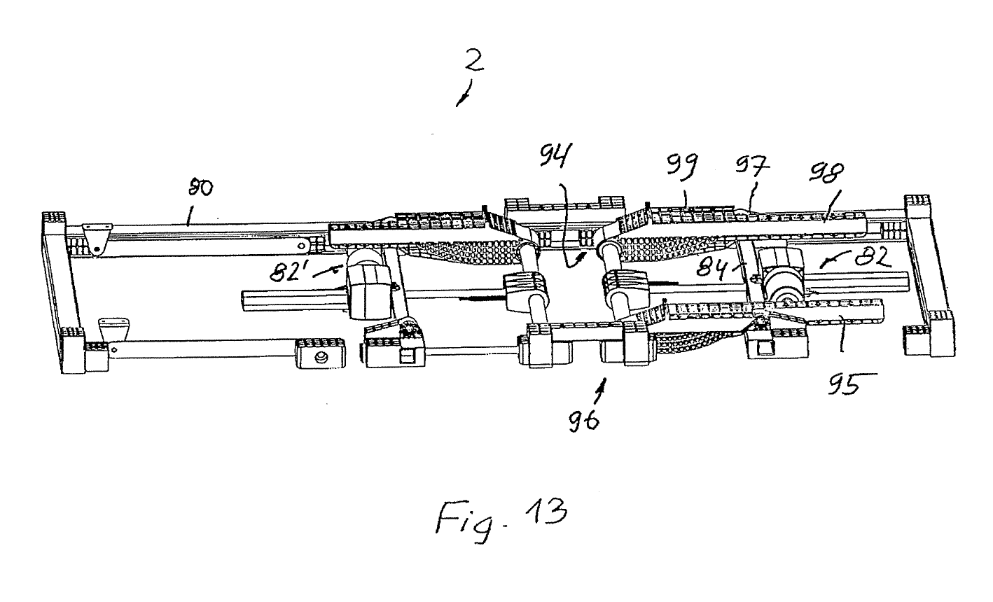

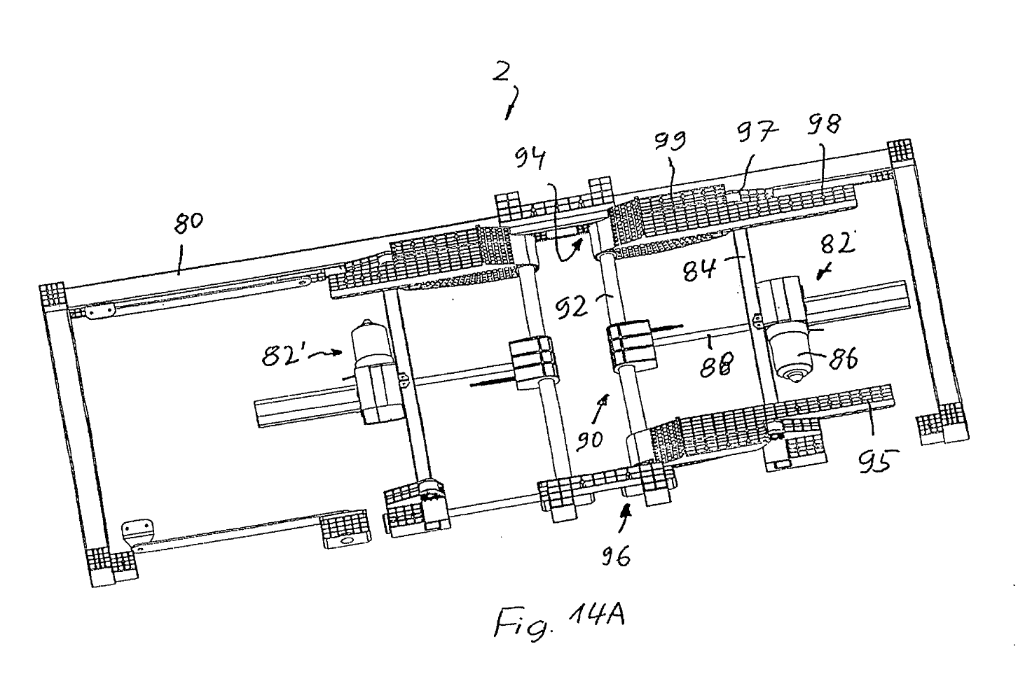

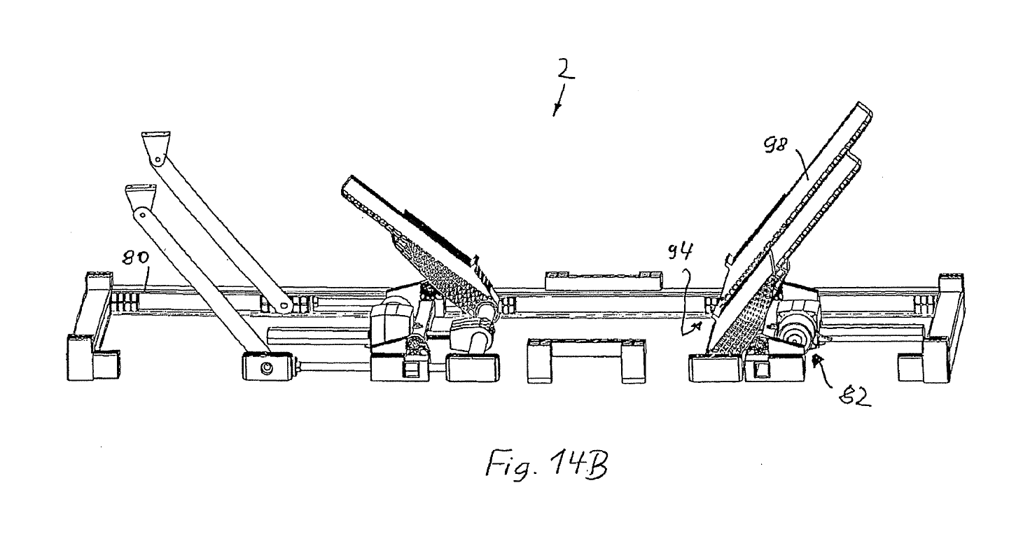

Drive apparatus 16 of the first embodiment is subsequently explained in greater detail on the basis FIGS. 13 through 14B. For purposes of illustration, various components of support apparatus 2 are omitted in FIGS. 13 through 14A.

FIGS. 13 and 14A show support apparatus in the starting position from different perspectives, while FIG. 14B shows support apparatus 2 in the end position of the adjustment movement.

In this embodiment, outer frame 26 has longitudinal beams 80, 80′, each of which are formed by a C-shaped profiled rail. The openings of the C-shaped profile of longitudinal beams 80, 80′, in this instance, are directed toward each other. To adjust upper body support part 8 relative to center support part 6, a drive unit 82 is provided, while for adjusting leg support part 12 including calf support part 14 relative to center support part 6 a further drive unit 82′ is provided. In the following, only drive unit 82 is explained in greater detail. Drive unit 82′ is correspondingly designed and its components are provided with reference characters which correspond to the reference characters of drive unit 82.

The drive unit has an electric motor 86 disposed at a stationary first transverse beam 84, which is in rotary drive connection with a rotary-drivable spindle nut disposed on a rotationally fixed and in the axial direction movable threaded spindle 88. The end of threaded spindle 88 facing away from electric motor 86, and therefore from the spindle nut, is connected in a displaceably fixed manner to a slide 90 having a second transverse beam 92, the ends of which are connected to slide elements 94, 96, each of which are captured in the C-shaped profiled rails of longitudinal beams 80, 80′ and are guided in a linearly displaceable manner in the direction of the profile. At transverse beam 92, pivotable longitudinal beams 98, 95 are mounted about a pivot axis defined by the transverse beam.

To adjust upper body support part 8 relative to center support part 6, electric motor 86 drives the spindle nut in such a manner that slide 90 translationally moves in the direction of first transverse beam 84. A first raising element 97 is disposed at first transverse beam 84, which acts together with a second raising element 99 connected in a pivotably fixed manner to longitudinal beam 98 to pivot upper body support part 8. The basic principle according to which upper body support part 8 simultaneously carries out a translational and a pivot movement is, thus, the same as in the illustrated embodiment.

The same applies to other longitudinal beam 95 of upper body support part 8.

As is apparent from FIGS. 14A and 14B, the lift of the translational movement of support body support part 8 is greater than in the first embodiment. This bears in mind the fact that for a box spring mattress, a greater lift is required to prevent a compression.

Also in the first embodiment, a compression of the mattress is prevented in the area of upper body support part 8 as well as also in the area of leg support part 12.

FIG. 14B shows support apparatus 2 in the end position of the adjustment movement.

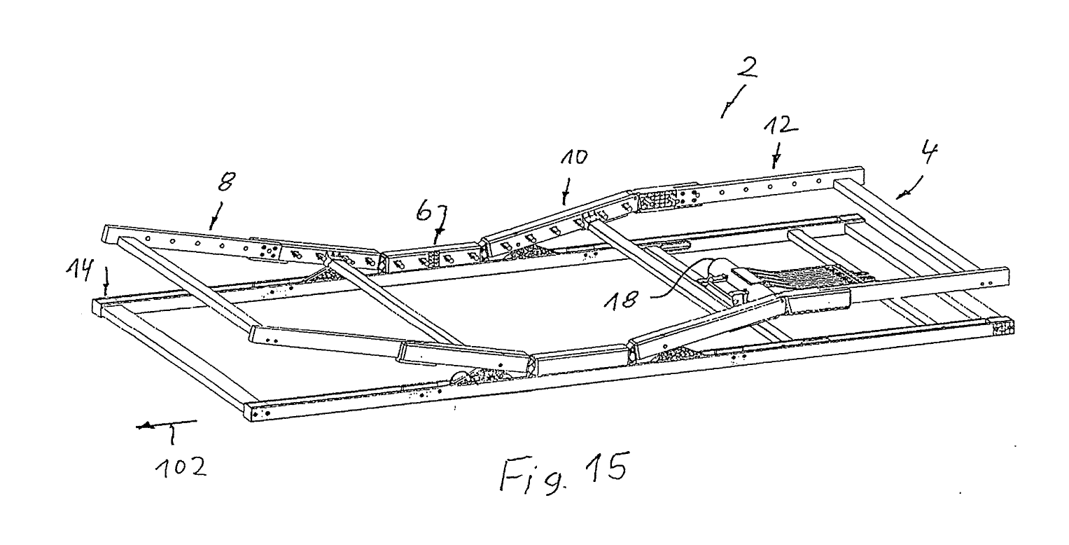

Subsequently, a second embodiment of a support apparatus according to the invention in the form of a slatted frame 2 is explained in greater detail in FIGS. 15 through 19.

In this embodiment, support apparatus 2 has a center support part 6, an upper body support part 8, a leg support part 10 and a calf support part 12.

In a starting position of the adjustment movement, support parts 6, 8, 10, 12 together span a substantially horizontal support plane to support a mattress not shown in the drawing. To simplify the illustration, elastic slats of slatted frame 2 are not illustrated in the drawing.

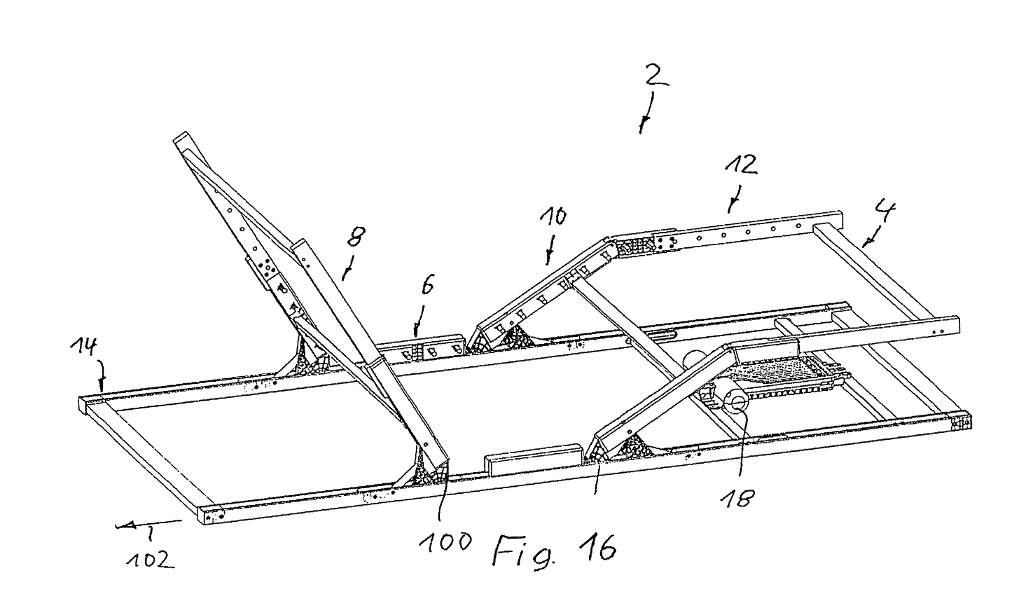

The underlying adjustment principle is subsequently explained in greater detail on the basis of an adjustment of upper body support part 8. To pivot upper body support part 8, an adjustment element, which in this embodiment is formed by a pivot lever 100 (see FIG. 16), is assigned to upper body support part 8 pivotably adjustable about a horizontal pivot axis relative to stationary center support part 6. In this embodiment, upper body support part 8 is operatively connected to pivot lever 100 in such a manner that upper body support part 8 during the pivot movement at least in phases carries out a translational movement along a linear axis relative to stationary support part 6. This linear axis is in FIG. 15 denoted by reference character 102. As is apparent from a comparison of FIGS. 15 and 16, upper body support part 8 during the pivot movement simultaneously carries out a translational movement along linear axis 102 and that is in such a manner that it moves away from stationary center support part 6. Since upper body support part 8 carries out a pivot movement as well as a translational movement, a compression of a mattress supported by slatted frame 2 (for purposes of clarity not illustrated in the drawing) is prevented.

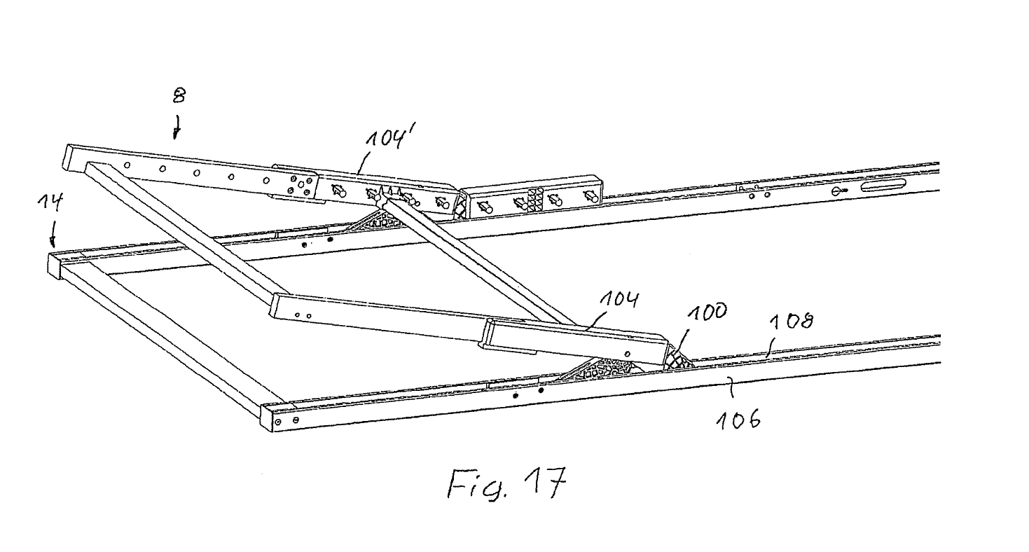

FIG. 17 shows a detail from FIG. 15 in the area of pivot lever 100 connected in a rotatably fixed manner to a side beam 104 of upper body support part 8. Slatted frame 2 is designed mirror-symmetrically in relation to its longitudinal center plane. Accordingly, in order to symmetrically transmit adjustment forces for the longitudinal center plane to upper body support part 8, a pivot lever 100′ corresponding to pivot lever 100 is also assigned to other longitudinal beam 104′ of the upper body support part. Operation and design of pivot lever 100′ corresponds to the operation and design of pivot lever 100. For this reason, exclusively the design and operation of pivot lever 100 are subsequently explained in greater detail.

Pivot lever 100 is guided at a linear guide along linear axis 102, this linear guide in the shown embodiment having a profiled rail 106. Profiled rail 106 is formed by a C-shaped profile having an opening (slot), the clearance of which is dimensioned in such a manner that the end of pivot lever 100 facing longitudinal beam 104 extends through the slot, pivot lever 100 however being captured by its opposite end in profiled rail 106. It is apparent from FIG. 17 that the openings of the C-shaped profiled rail forming the longitudinal beams are mutually parallel.

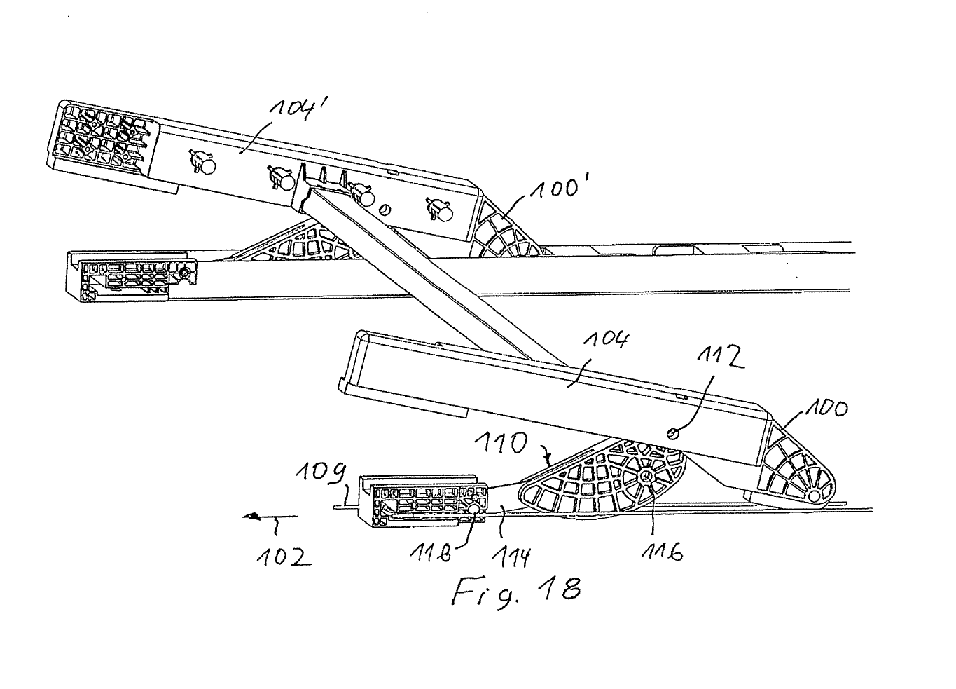

FIG. 18 shows a detail in the area of pivot lever 100, the profiled rail being omitted for purposes of illustration.

A raising means serving to raise and pivot pivot lever 100 during the translational movement is assigned to pivot lever 100.

To achieve a translational movement of pivot lever 100 in the direction referenced by arrow 102, the end of a pull cable of a Bowden cable, not shown in the drawing for purposes of clarity, is fixed at pivot lever 100. The other end of the pull cable is guided to drive unit 18 (see FIG. 15).

In the shown embodiment, the raising means is a raising lever 110, one end of which is connected articulately and pivotable about pivot axis 110 eccentric and parallel to the pivot axis of pivot lever 100 to pivot lever 100. The other end of raising lever 110 rests at the onset of the adjustment movement at a support plane on the bottom of the guide formed by profiled rail 106.

In the illustrated embodiment, the design is selected in such a manner that the pull cable of the Bowden cable pulls pivot lever 100 toward raising lever 110. So that raising lever 110 serves as a counter bearing for pivoting pivot lever 110, a counter bearing element is assigned to the raising lever. In this embodiment, the counter bearing element is formed by a lug 114 subjected to pressure during pivoting the pivot lever, one end of which eccentric to pivot axis 112 is connected rotatable about a rotary axis 116 to raising lever 110, and the other end of the lug is rotatably connected to a rotary bearing 118 being stationary during the adjustment of pivot lever 110.

Based on a starting position of the adjustment movement, in which upper body support part 8 together with stationary center support part 6 and the additional support parts 10, 12 essentially span a horizontal support plane, the pivot adjustment of upper body support part 8 takes place in such a manner that a traction effect onto pivot lever 110 is exerted via the pull cable of the Bowden cable, so that pivot lever 110 carries out a translational movement in the direction of arrow 102, the pivot lever being pulled toward raising lever 110 which rises and, in so doing, pivots pivot lever 100. FIG. 18 shows an adjustment position in which pivot lever 110 counter to a starting position of the adjustment movement has moved in the direction 102 away from center support part 6 as well as is also pivoted about its pivot axis in FIG. 18, the pull cable of the Bowden cable assigned to pivot lever 100 is denoted by the reference character 109.

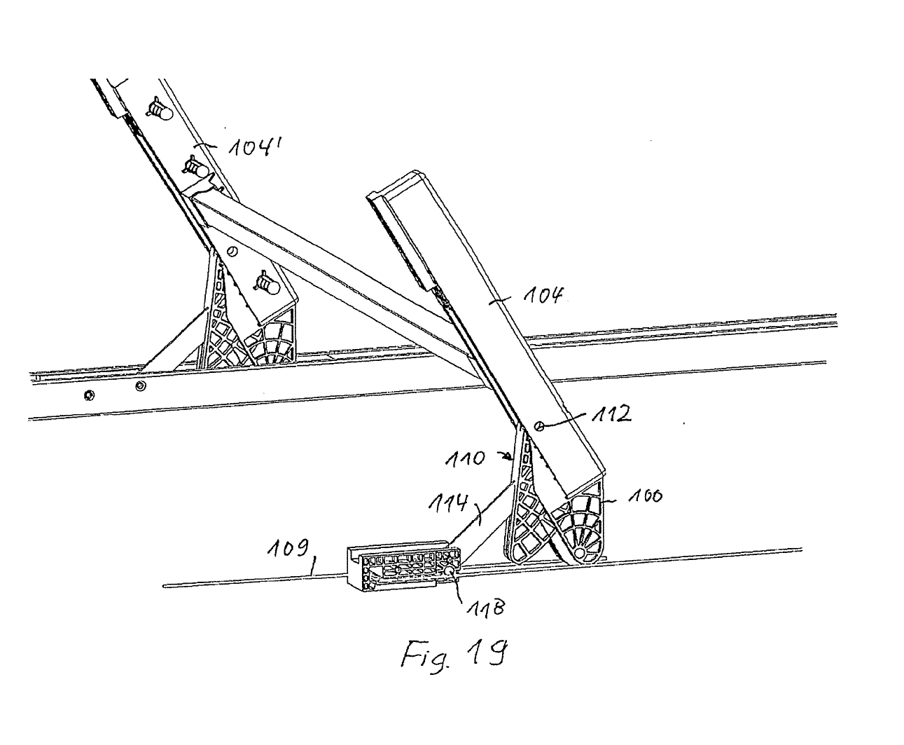

During the further course of the adjustment movement, pivot lever 100 moves translationally further into the direction of arrow 102 and, in so doing, is further pivoted, until the end position of the adjustment movement shown in FIG. 19 is reached, in which raising lever 110 is completely lifted from the support plane formed by the bottom of profiled rail 106.

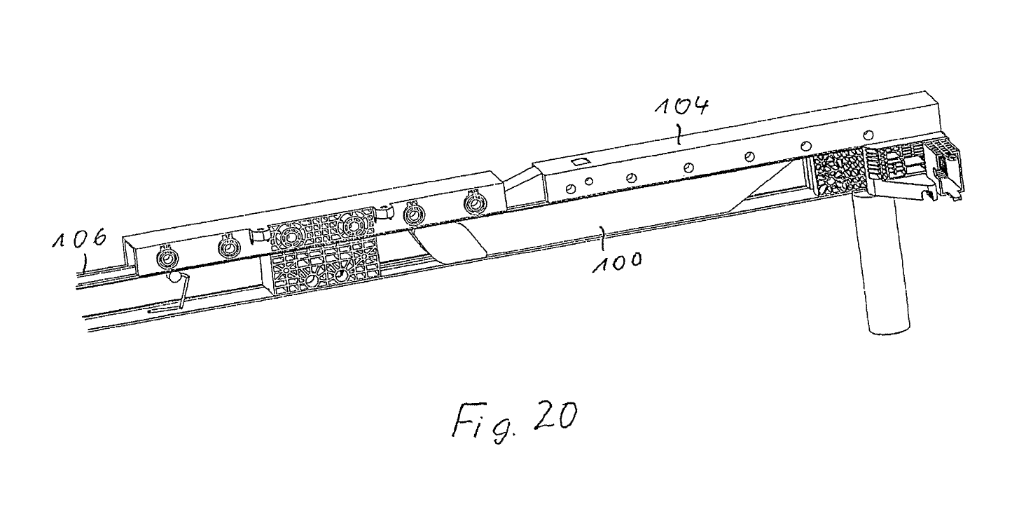

On the basis of FIGS. 20 through 23, a fourth embodiment of a support apparatus according to the invention is subsequently explained, for purposes of illustration, only the area of pivot lever 100 being shown. As in the embodiments described previously, the pivot lever by its end facing away from longitudinal beam 104 of upper body support part 8 is captured in profiled rail 106.

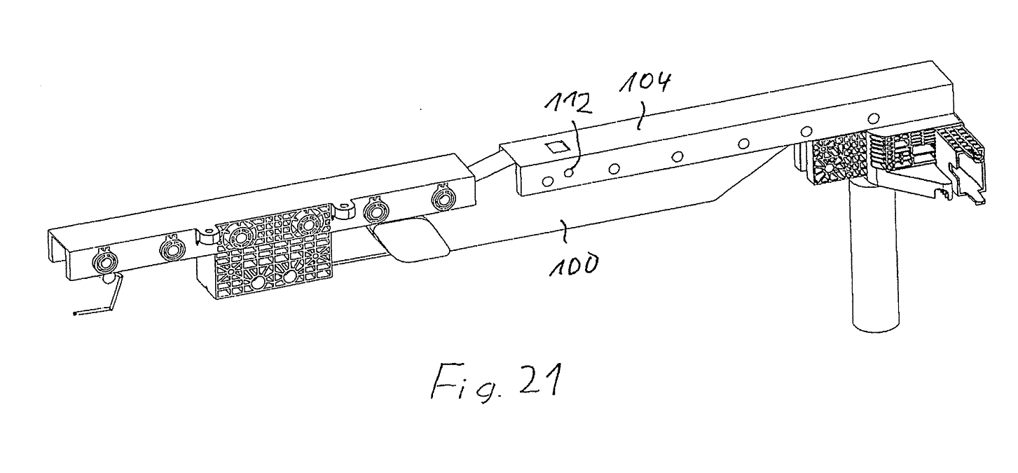

FIG. 20 shows the starting position of the adjustment movement, in which upper body support part 8 together with the other support parts span a horizontal support plane. For purposes of illustration, profiled rail 106 is omitted in FIGS. 21 through 23.

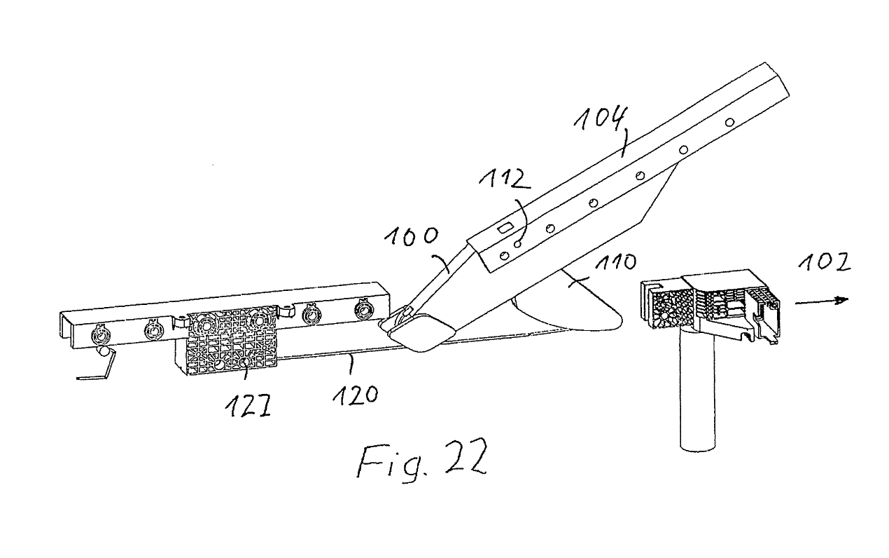

The embodiment shown in FIGS. 20 through 23 differs from the embodiment shown in FIGS. 15 through 19, in particular in that the counter bearing element is designed as a cable subjected to traction during the pivoting of pivot lever 100. Cable 120 may, for example, be formed by a thin wire cable. It however may also be replaced by a different band or chain-like traction means. One end of cable 120 eccentric to pivot axis 112 is fixed at raising lever 110. The other end of cable 120 is fixed at an attachment point 122 being stationary during a pivoting of the pivot lever (see FIG. 22).

From FIG. 22 it is apparent that cable 120 runs below the end of pivot lever 100 resting on the bottom of the profiled rail and is guided to attachment point 122.

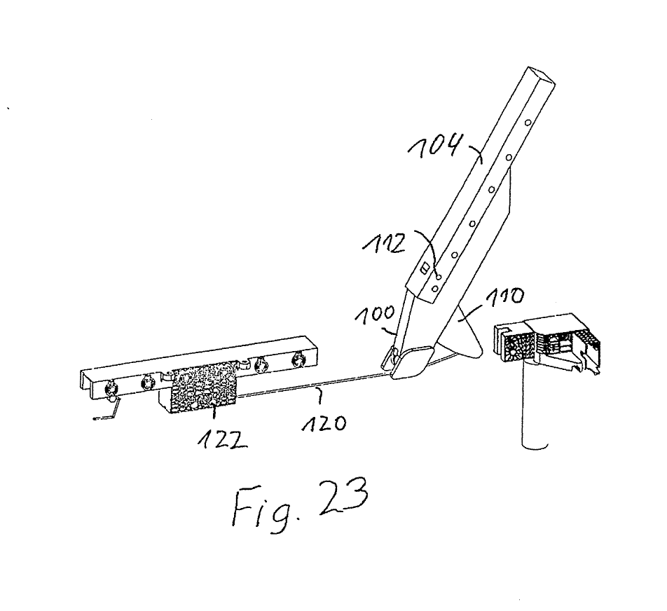

The adjustment of pivot lever 100 is carried out based on the starting position of the adjustment movement shown in FIG. 21 in such a manner that pivot lever 100 is, with the aid of the Bowden cable again omitted for purposes of clarity, pulled in the direction of arrow 102 toward raising lever 110. In the manner described for the previous embodiment, pivot lever 100 in this instance simultaneously carries out a translational movement in the direction of arrow 102 as well as also a counterclockwise pivot movement in FIG. 22 until the end position of the adjustment movement shown in FIG. 23 is reached.

The shown embodiments both emulate the function of a bow hinge, in which the pivot axis, about which pivot lever 100 is effectively pivoted, is displaced in an area above pivot lever 100 and, therefore, factually into the area of the mattress supported by slatted frame 2.

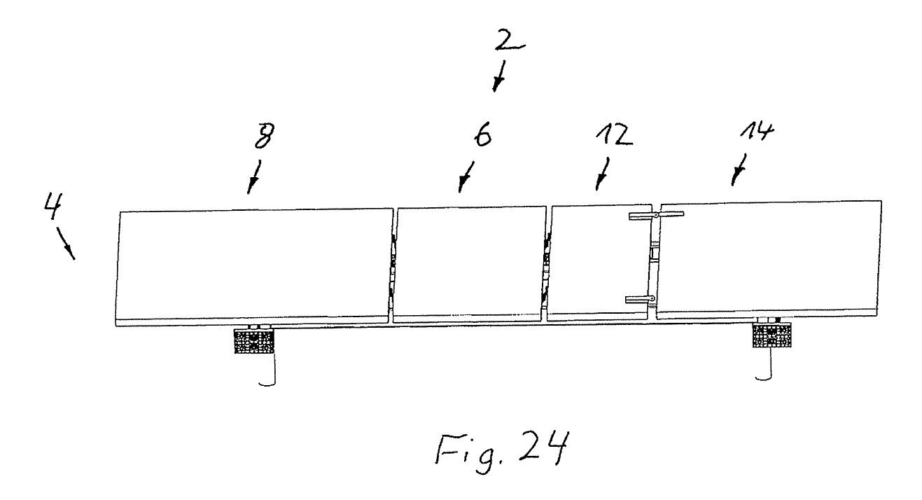

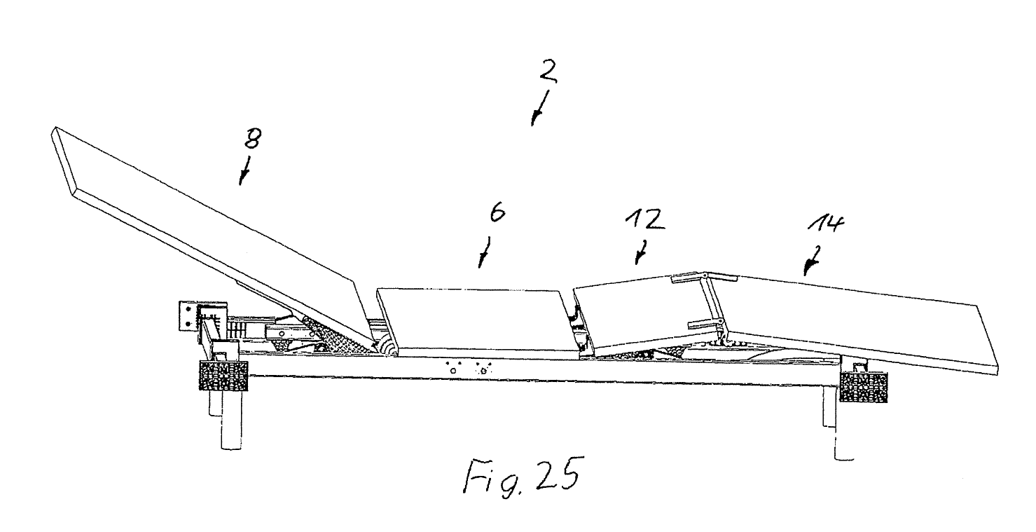

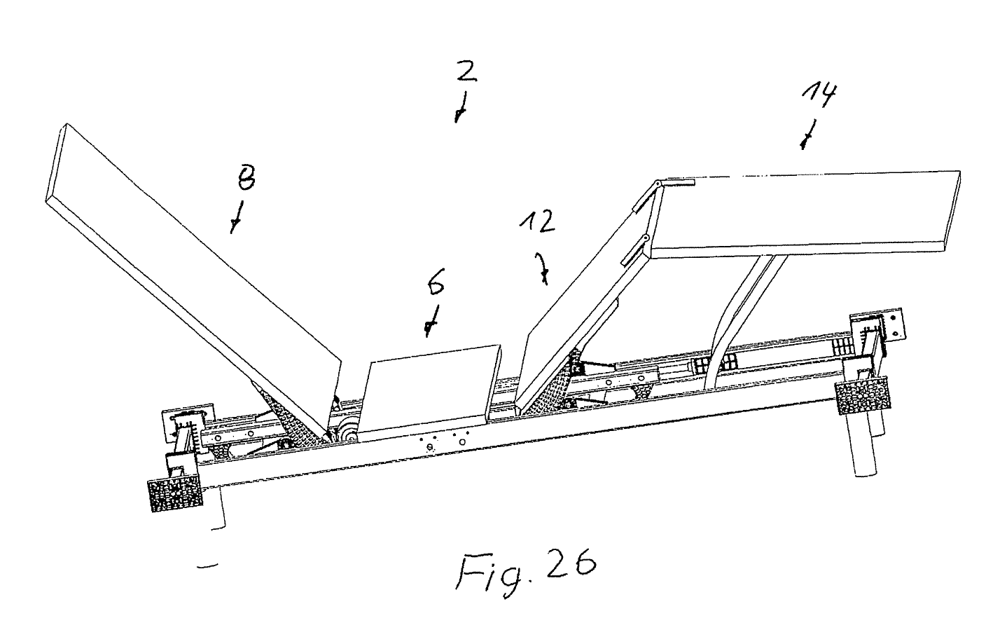

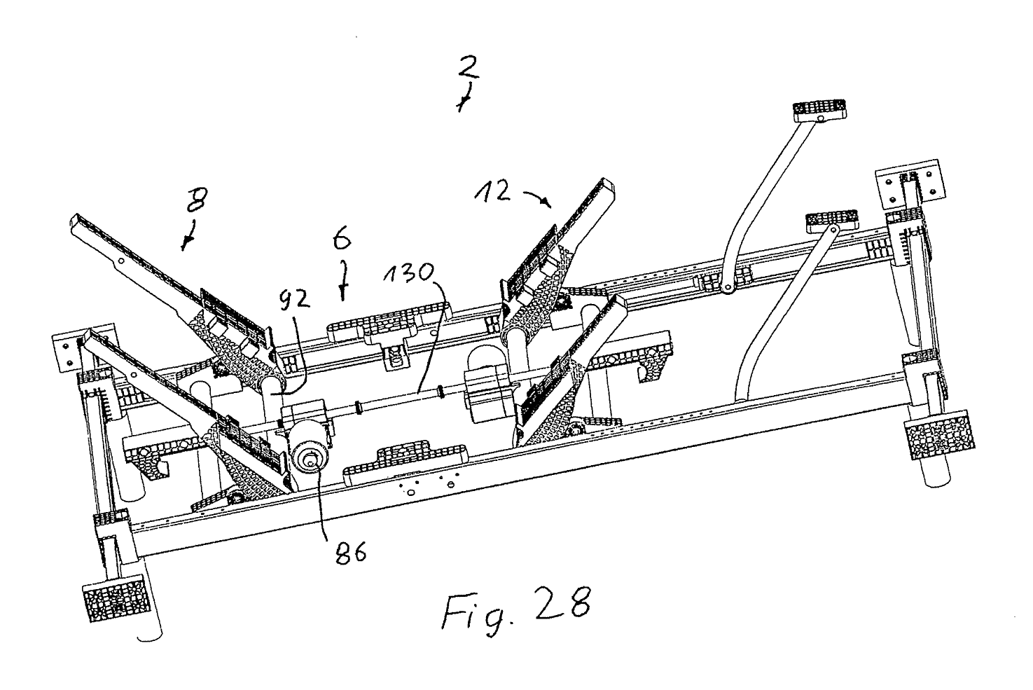

In reference to FIGS. 24 through 30, a fourth embodiment of a support apparatus 2 according to the invention is subsequently explained, which in its design and mode of operation largely corresponds to the embodiment according to FIGS. 10 through 14B. In particular, the embodiment shown in FIGS. 24 through 30 is also configured to support a box spring mattress. In this embodiment, the longitudinal beams of outer frame 20 are also formed by a C-shaped profile.

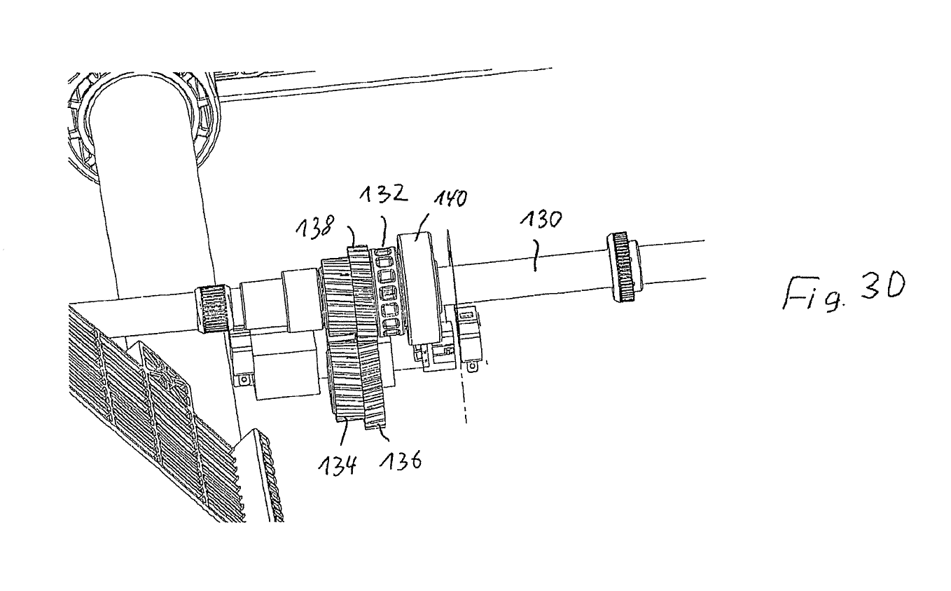

The embodiment according to FIGS. 24 through 30 also corresponds to the embodiment according to FIGS. 10 through 14B as far as in that a spindle drive is provided for transmitting the actuating force of electric motor 86 to the to-be adjusted support part. In contrast to the embodiment in FIGS. 10 through 14B, the mode of operation of the spindle drive is however kinematically reversed. While in the embodiment according to FIGS. 10 through 14A the driving element of the drive unit is formed by a threaded spindle 88 movably mounted in its axial direction (see FIG. 14A), on which a stationary spindle nut rotary-drivable with the aid of electric motor 86 is disposed, the embodiment according to FIGS. 24 through 30 has a stationary threaded spindle 130 disposed and fastened below support parts 6 through 14. A spindle nut 132 rotary-drivable with the aid of electric motor 86 is fitted onto threaded spindle 130 (see FIG. 30). The drive shaft of electric motor 86 is configured as a worm gear which is in engagement with a worm gear wheel 134, to which a spur wheel 136 is connected in a rotationally fixed manner, which is in engagement with a further spur wheel 138 connected in a rotationally fixed manner to spindle nut 132. Corresponding to the direction of rotation of the drive shaft of electric motor 86, spindle nut 132 is thereby rotated in one or the other direction of rotation, so that it is moved in the axial direction of threaded spindle 133.

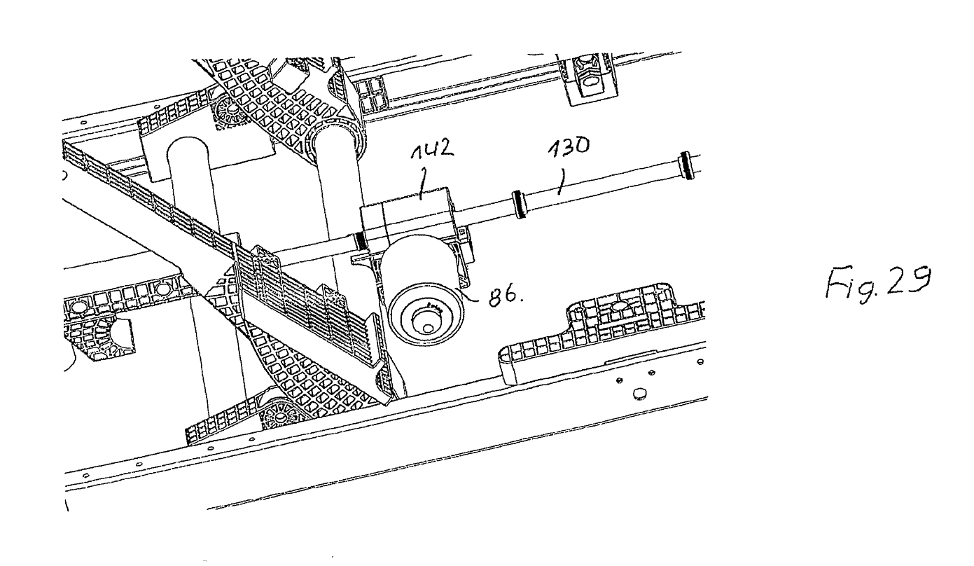

Spindle nut 132 is mounted with the aid of a ball bearing 140 at a housing 142, at which electric motor 86 is disposed. Housing 142 is connected to transverse beam 92 (see FIG. 29) in a displaceably fixed manner.

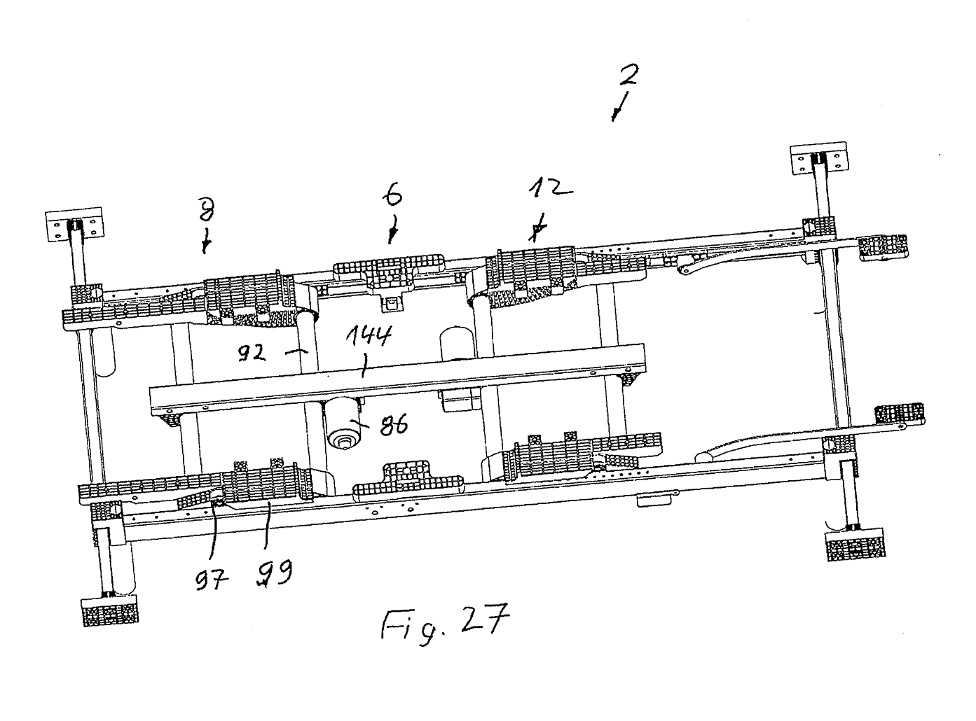

Threaded spindle 130 is covered with the aid of a cover (see FIG. 27).

Based on the starting position of the adjustment movement shown in FIG. 27, electric motor 86 for adjusting upper body support part 8 relative to center support part 6 actuates spindle nut 140 in such a manner that the spindle nut moves on threaded spindle 130 in FIG. 27 to the left. On account of the displaceably fixed connection of housing 142 to transverse beam 92, transverse beam 92 in FIG. 27 is in this instance displaced to the left, so that the upper body support part is pivoted in a manner described previously on the basis of the embodiment according to FIGS. 10 through 14B.

The adjustment mechanism for adjusting leg support part 12 including calf support part 14 relative to center support part 6 is designed accordingly and, for this reason, is here not described in greater detail. Likewise, the assigned spindle nut runs on threaded spindle 130.

In the different figures of the drawing and the different embodiments, the same or corresponding components are provided with the same reference characters. Insofar as components are omitted in the figures of the drawing for purposes of illustration or clarity, the respective components are each to be accordingly added in these figures. It is apparent for those skilled in the art that the features of the individual embodiments are also exchangeable among embodiments, thus, the features disclosed in reference to an embodiment may also be identically or logically provided in the other embodiments. Furthermore, it is apparent to those skilled in the art that the features disclosed for the individual embodiments further refine the invention in their own right, thus, independent from further features of the respective embodiment.

Insofar as the individual components for purposes of illustration are omitted in the different figures of the drawing, these components are to be logically added in the respective figures. The features of the individual embodiments or illustrated embodiments are also exchangeable among embodiments or illustrated embodiments, thus, the features disclosed in reference to an embodiment or illustrated embodiment may be also provided identically or logically in the other embodiments or illustrated embodiments. The features disclosed in the individual embodiments or illustrated embodiments further refine the respective embodiment or illustrated embodiment respectively in their own right, thus, independent from further features of this embodiment or illustrated embodiment.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. A support apparatus adjustable by an electric motor for supporting padding of a seat or a reclining furniture, comprising:
a) a base body, the base body having an outer frame for resting on a support surface and an inner frame having at least two support parts adjustable relative to one another;
b) a drive apparatus, the drive apparatus having at least one adjustment element in drive connection with at least one electric motor which for adjusting at least one support part is in drive connection with the at least one electric motor;
c) an outer frame, at least in sections, being formed by a C-shaped profiled rail; and
d) the C-shaped profiled rail forming a linear guide, by which the at least one adjustment element is guided in the direction of the profile in a linearly displaceable manner.

2. The support apparatus according to claim 1, wherein:
a) the outer frame has two longitudinal beams at a distance to each other extending transversely to the longitudinal direction of the support apparatus, of which at least one longitudinal beam, at least in sections, is configured as a C-shaped profiled rail.

3. The support apparatus according to claim 2, wherein:
a) the two longitudinal beams, at least in sections, are configured as a C-shaped profiled rail, and the openings of the C-shaped profile of the two longitudinal beams are facing each other.

4. The support apparatus according to claim 2, wherein:
a) the two longitudinal beams, at least in sections, are configured as a C-shaped profiled rail, and the openings of the C-shaped profile of the two longitudinal beams are mutually parallel.

5. The support apparatus according to claim 4, wherein:
a) the openings of the C-shaped profile are directed upward when the support apparatus is in a use position.

6. The support apparatus according to claim 2, wherein:
a) the two longitudinal beams of the outer frame at their ends, or in the area of their ends, are connected to each other by transverse beams.

7. The support apparatus according to claim 1, wherein:
a) the C-shaped profiled rail is made of one of metal and plastic.

8. The support apparatus according to claim 1, wherein:
a) the at least one adjustment element is a pivot lever, set up so that the pivot lever during a linear movement along the linear guide pivots under the effect of the drive apparatus for adjusting the at least two support parts relative to each other.

9. The support apparatus according to claim 8, wherein:
a) the pivot lever under the effect of a traction element in drive connection with the drive apparatus is linearly movable.

10. The support apparatus according to claim 9, wherein:
a) the traction element is a pull cable of a Bowden cable.

11. The support apparatus according to claim 1, wherein:
a) the cross section of the at least one adjustment element is configured so that a first end of the adjustment element facing the bottom of the C-shaped profiled rail is captured in the C-shaped profile and that a second end of the at least one adjustment element facing away from the first end protrudes through the opening of the C-shaped profile and is in operative connection with a to-be-adjusted support part.
